(19) United States
(12) Patent Application Publication
(10) Pub. No.: US 2010/0299892 A1
(43) Pub. Date: Dec. 2, 2010

(54) CLIPS

(76) Inventor: Fergus Johnathan Ardern, Norfolk (GB)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/744,956

(22) PCT Filed: Oct. 17, 2008
(86) PCT No.: PCT/GB08/50952

§ 371 Date: May 27, 2010

(30) Foreign Application Priority Data
Nov. 27, 2007 (GB) 0723180.6
Jul. 17, 2008 (GB) 0813083.3

(51) Int. Cl. F16B 2/26

(52) U.S. Cl. 24/481

(57) ABSTRACT

A clip (1) formed of a resiliently deformable material in the form of a split ring. Each end of the split ring is provided with a tab (9) and hole (10) having a ratchet mechanism (11, 12) to provide non-releasable closure. Further embodiments have a hole arrangement to allow release of the closure by twisting the ring.

### FIELD OF THE INVENTION

The invention relates to clips for tying items together, such as cables and pipes; for sealing the open ends of bags or sacks; and also for clips to attach items such as signs to supporting structures such as posts. The invention also relates to clip assemblies, for connecting items together, and for use as a construction element.

### BACKGROUND AND PRIOR ART KNOWN TO THE APPLICANT

A large number of clips and closures are known in the art that may be used to secure items such as signs to posts and the like, or can be used to clip together a number of cables or pipes or to seal the open end of bags or sacks. A common example of clips of this type is known as a “tie wrap” having a flexible strap member with a receiving portion at one end provided with a slot to receive the other end of the strap to form an encircling band. The strap and receiving member are provided with a ratchet mechanism to allow a one-way only insertion of the free strap end to effect a non-releasable attachment or closure as described above. One problem evident with clips of this sort is that they require two-handed operation to secure them, and, once secured, cannot be released other than by breaking the strap. Tie-wraps of this type also require significant manual dexterity to align the strap end with the slot, making them difficult to use e.g. with a gloved hand. It is amongst the objects of the present invention to provide a solution to these and other problems.

### SUMMARY OF THE INVENTION

Accordingly, the invention provides a clip comprising: a ring of deformable material; said ring having a split defining a gap between opposing gap faces of said ring; one gap face having a tab and the other gap face having a hole configured such that the tab enters the hole of the opposing gap face when the ring is deformed to bring said opposing gap faces together; the tab and hole being provided with a ratchet mechanism to resist removal of the tab from the hole; and outwardly protruding gripping portions located on the outer face of said ring to act as levers, thereby enabling a user to bring said gap faces towards each other by bringing the gripping portions together. Preferably, the ring is made of resiliently deformable material, so that the gap faces spring apart from each other to allow the clip to be positioned over an item to be clipped. The ratchet mechanism may comprise a single position one-way lock, or, preferably, be a multi-position ratchet, thereby allowing the clip to be secured in a number of positions. In this way, a clip can be tightened progressively around an object such as the neck of a sack, or bag, or can accommodate items of varying size.

It is particularly envisaged that the clip will be so sized as to allow the lever gripping portions to be operated by the thumb and finger of a user, when in use. More preferably, the gripping portions extend beyond the ratchet mechanism to provide lever advantage to aid a user operating the ratchet. More preferably, the gripping portions are located beyond the ratchet mechanism.

Preferably, the clip comprises two such tabs and holes. This provides extra strength to the device, and a “back-up” locking mechanism in the event of failure of one ratchet. More preferably, each opposing gap face has a tab and a hole. By mounting a tab and a hole on each opposing gap face, a user will always be able to see (or feel) one of each, despite the orientation of the clip.

In any aspect of the invention, it is preferred that in said ring (having an end face), the hole or holes are open to an end face of the ring, whereby the ratchet mechanisms may be released by twisting the ring and thereby displacing the gap faces relative to each other along the direction of the axis of the ring. In this configuration, the tab portion(s) of the ratchet can slide along the hole (or slot) to leave the body of the ring by means of the opening onto the end face. Preferably, in the ring (having two end faces) said holes are each open to both end faces of the ring, thereby allowing the ratchet mechanisms to be released by twisting the ring in either of two directions.

The term “face” is used herein to define positions on the outer surface of the ring, and does not necessarily imply the existence of any flat face on the ring surface; a smooth, edge-free profile of ring would be equally suitable.

It is also preferred that, the holes are open to opposing end faces of said rings, and more preferably, that the hole and tab of each gap face are positioned adjacent each other along the axial dimension of the ring.

In any aspect of the invention, it is preferred that said ring is provided with a slot, such as an annular slot, running around the ring, between each end face. Preferably, the clips further comprise an abutment block located within said slot.

Also in any aspect of the invention, it is preferred that the inner face of said ring is ridged. The embodiments of the invention described below have generally circular-shaped rings, also it is envisaged that other shapes forming a closed loop may be employed. In especially preferred embodiments, the inner face of the ring is shaped to cooperate with an item to be clipped. For example, the inner face of the ring may define a rectangular (or square) opening, allowing the ring to be readily and firmly clamped to a square-section post, such as a fence post. Other cooperating shapes are also envisaged, such as more generally polygonal (e.g. hexagonal), ovoid or having an irregular profile.

Also included within the scope of the invention is a clip substantially as described herein, with reference to and as illustrated by any appropriate combination of the accompanying drawings.

In a further aspect, the invention provides a clip as described above, further comprising connection means to enable the clip to be connected to a like clip. Preferably, said connection means are located on said ring. Alternatively, or in combination, it is preferable that said connection means are releasable. More preferably also, and again alternatively or in combination, said connection means provide a rotatable connection to a like clip. Most preferably, the clip comprises a plurality of such connection means.

The provision of such connection means allows not only the clip to be used to e.g. close the end of a bag, or secure a bundle of items together, but allows multiple clips to be used to connect items together, or to tether one item to another. For example, a double clip might be used to attach a plant to a support stake or wire. The provision of a plurality of such connection means allows an assembly of clips to be created, giving flexibility to their use. In this way, for example, a loop or band of multiple clips may be created to suit a particular situation, for example to create a support structure for an array of plant supports. Where the connection means is arranged to provide a rotatable connection, this provides functionality, e.g. to allow one clipped item to move relative to another, so preventing potential damage to either when moved relative to each other.

In a further aspect, the invention also provides a clip assembly comprising a plurality of clips as described above, each of said clips being joined to an adjacent clip, and preferably where adjacent clips have a different orientation. Provision of adjacent clips in different orientations improves access to the gripping portions by a user's fingers.

Preferably, at least two of said clips are oriented such that the axes of their rings are non-parallel. In this way, the clips may be used in the construction of space-filling lattices.

### BRIEF DESCRIPTION OF THE DRAWINGS

The invention will be described with reference to the accompanying drawings in which

FIGS. 1 and 2 illustrate, in perspective view, an embodiment of a clip according to the invention;

FIG. 3 illustrates, in perspective view, a clip in a deformed configuration;

FIGS. 4-5 illustrate embodiments of tab and slot configurations of clips according to the present invention;

FIGS. 6-7 illustrate, in perspective view a further embodiment of the invention;

FIG. 8 illustrates a cross-sectional view of the embodiments of FIGS. 6-7;

FIGS. 9-10 illustrate in schematic cross-sectional view two embodiments of clips;

FIGS. 11-14 illustrate embodiments of multi-clip assemblies;

FIGS. 15-16 illustrate clips having rotatable connection means;

FIG. 17 illustrates a clip having a plurality of connection means; and

FIGS. 18 and 19 illustrate embodiments of the invention having a ring abutment block between portions of a split ring.

### DESCRIPTION OF PREFERRED EMBODIMENTS

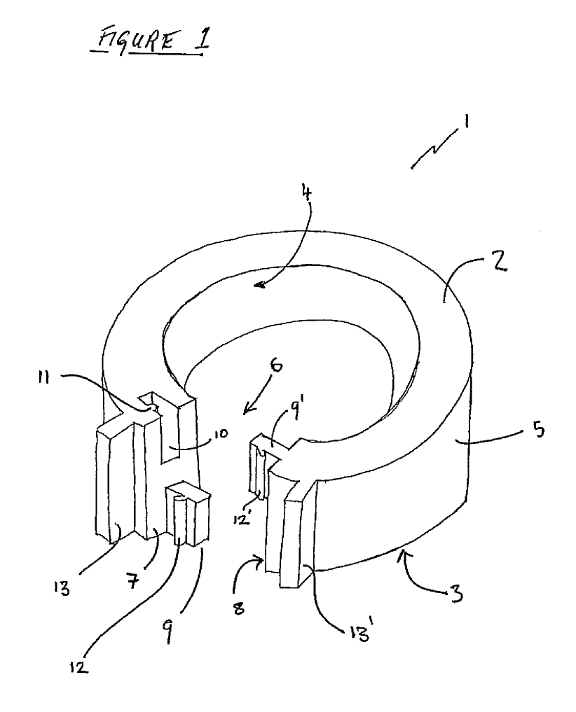

FIG. 1 illustrates, in perspective view, a clip, generally indicated by 1, according to the present invention. The clip 1 comprises a ring of resiliently deformable material, such as plastics. The ring has two end faces 2 and 3, an inner face 4 and an outer face 5. The ring is split, thereby defining a gap 6 within the circumference of the ring and exposing two gap faces 7 and 8. In this preferred embodiment the ring is constructed such that in its non-deformed configuration the gap 6 is open, allowing the clip to be readily slipped around an object to be constrained by the clip. On each gap face 7, 8 there is a tab 9, 9′ and a hole, in the form of a slot, 10 (and 10′, not visible in FIG. 1). The tab 9 and slot 10 on each gap face are configured such that when the ring is deformed to bring two gap faces together, tab 9 will enter the corresponding slot 10′ on the opposite gap face whilst tab 9′ will enter the slot 10 on its opposite gap face. Corresponding tabs and slots are provided with a ratchet mechanism to resist removal of tab from a slot (in the same direction that it entered). In the embodiment of FIG. 1, this ratchet mechanism is provided by the provision of a detent in the form of a ridge 11 located on an inside face of the slot 10, a corresponding pawl 12, 12′ on the outer face of the tab 9′. In further envisaged embodiments, the detent (or detents) may have the form of serrations, e.g. triangular cross-section serrations, rather than the more rounded shape illustrated.

It can be seen in FIG. 1, that the slot 10 and tab 9 of each gap face 7 are positioned adjacent each other along the axial dimension of the ring. Being constructed from a resiliently deformable material, as the tab enters the slot, the pawl (and the adjacent region of ring material) will deform to allow the pawl to engage with the detent, thus holding the tab within the slot.

Also provided in this embodiment are outwardly protruding gripping portions, 13, 13′ to enable a user to more easily bring the two gap bases of the ring together thus engaging each corresponding pair of tabs and slots to secure the ring in a closed position. For some embodiments, the gripping portions can be quite small, perhaps 5-10 mm, to allow the ring to be closed using a pair of pliers. Other embodiments (described below) might have larger gripping portions configured to allow closure by thumb and finger. The gripping portions are arranged on the ring so that they act as levers, thereby enabling a user to bring the two gap faces towards each other with less force than would otherwise be required.

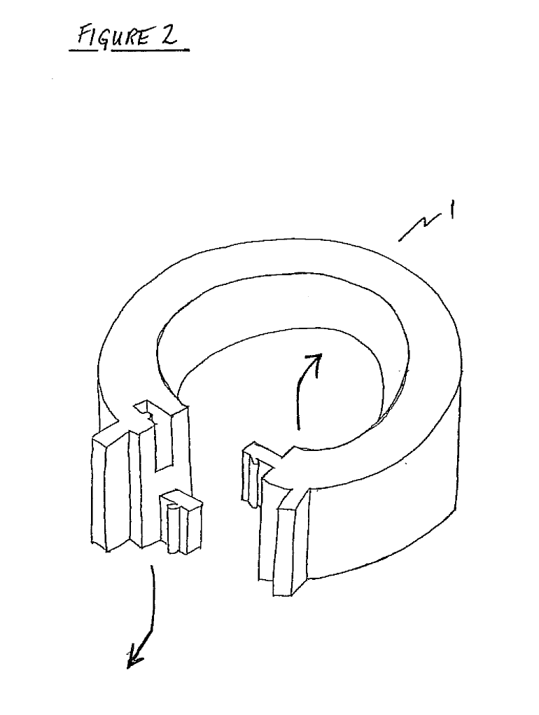

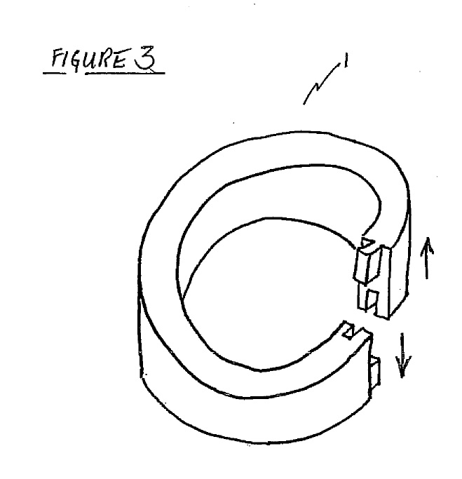

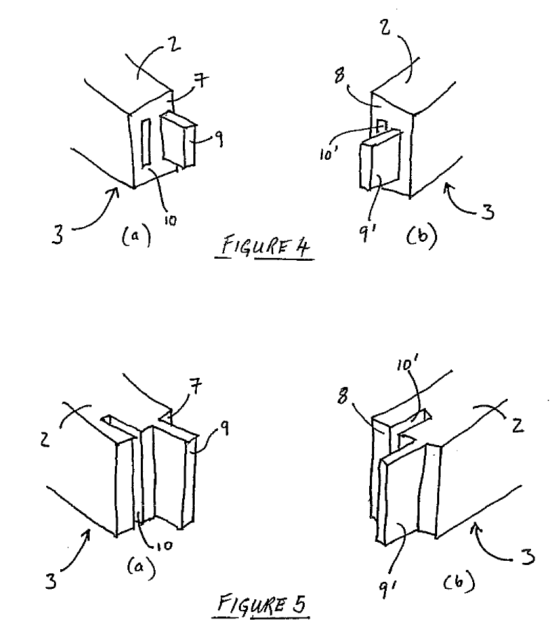

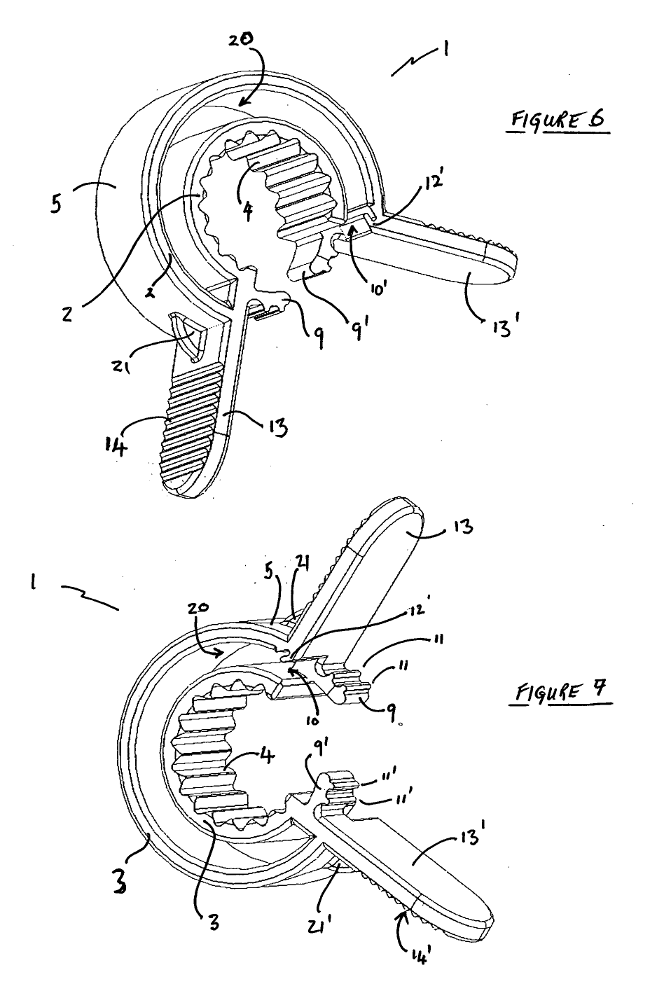

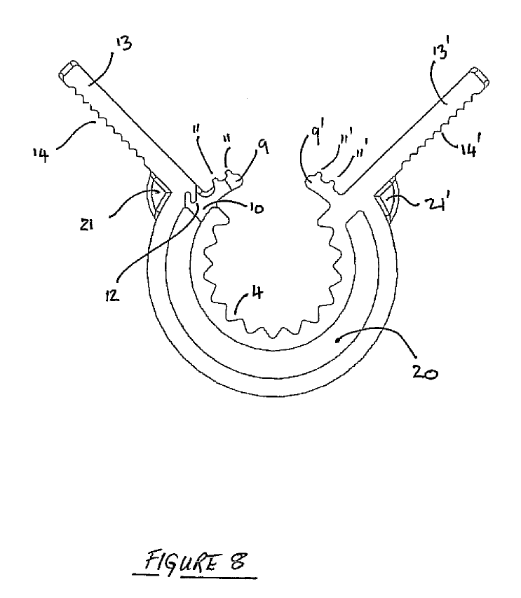

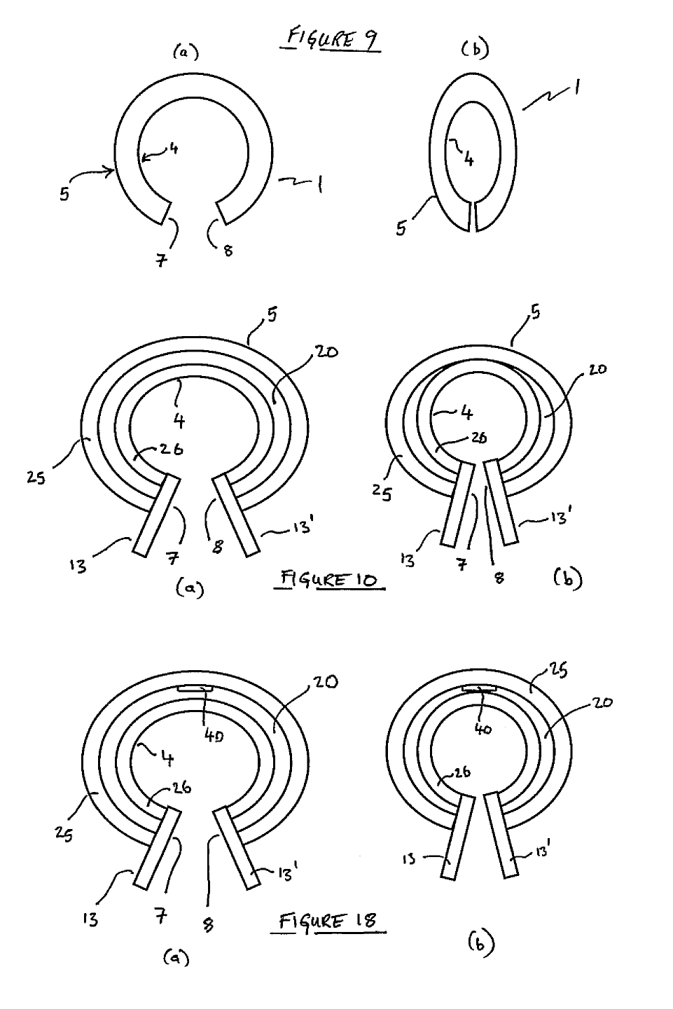

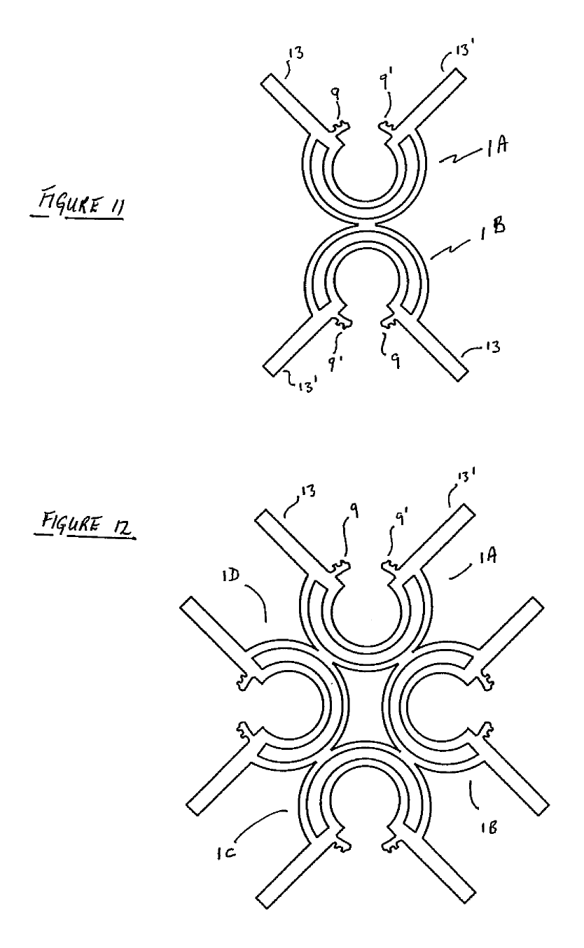

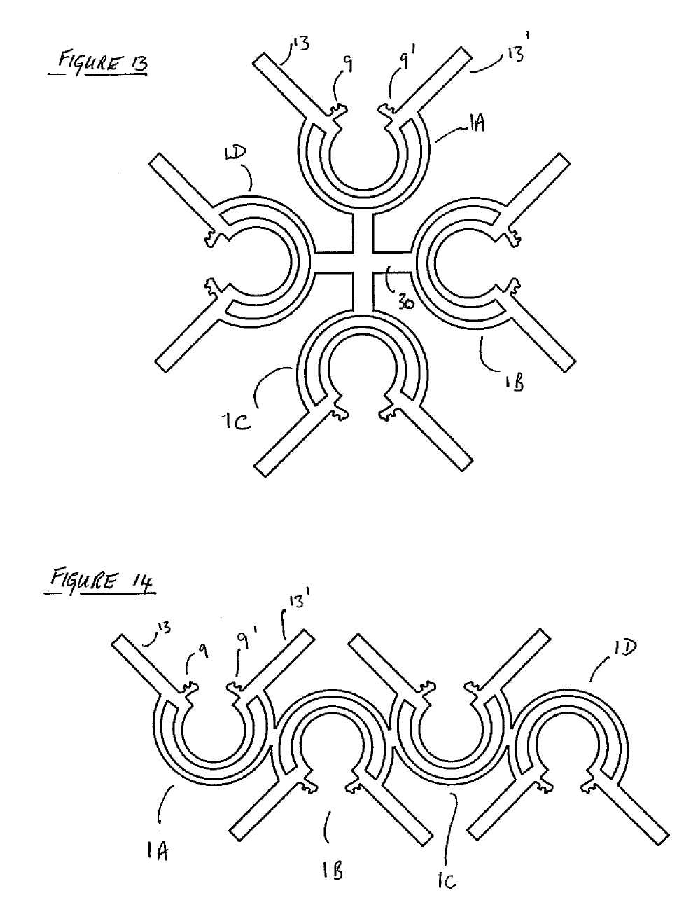

In the embodiment of FIG. 1, each of the slots 10, 10′ (of which only slot 10 is visible) is open to an opposite end face of the ring: slot 10, as well as being open to the gap face 7 is also open to the end face 2; the corresponding slot 10′, as well as being open to gap face 8, is also open to end face 3. By opening the slots to the opposite end faces in this way, the ratchet mechanism may be released by twisting the ring and thereby sliding the two gap faces apart in the direction illustrated by the arrows in FIG. 2. FIG. 3 illustrates a clip in its deformed configuration showing how the corresponding tabs and slots can disengage from the ratchet mechanism, thus opening the clip to its original configuration of FIG. 1. For clarity, the pawls and ridges have been omitted from FIG. 3.

FIGS. 4 and 5 illustrate alternative embodiments of the tab and hole arrangements for each end of the gap faces 7 and 8. Again, for clarity, the ratchet mechanisms have been omitted from FIGS. 4 and 5. FIGS. 4(a) and 4(b) illustrate corresponding ends of a split ring forming part of a clip wherein tab 9 and hole 10 elements (the holes being in the form of slots) are arranged adjacent each other along a radial dimension of the ring. In this embodiment, the slots 10, 10′ do not open onto the end faces 2 and 3 of the ring and so provide a one-way and essentially permanent closure. A configuration of this sort provides a clip suitable for a secure closure, or one that provides evidence of tampering. If the ring material is significantly thicker than that used in a typical tie-wrap, e.g. having a ring cross-sectional area of at least 0.5 cm², or even greater than 1 cm², it will be difficult to cut the ring without the use of a saw, thereby giving added security.

FIGS. 5(a) and 5(b) illustrate a further alternative embodiment in which the holes 10 and 10′ open to both the end faces 2 and 3 of the ring. In this way, the ratchet mechanism may be disengaged by twisting the ring in either direction.

FIGS. 6 and 7 illustrate, in perspective view, a yet further embodiment of the invention. In this embodiment, the ring is provided with an annular slot 20 extending between the two end faces 2 and 3 of the ring. The benefits of constructing the ring in this way will be described more fully below. The annular slot 20 is in communication with the inward-most end of the gap face slots 10 and 10′, in each of which is situated the two pawls 12 and 12′, each forming one half of each ratchet mechanism.

Each of the tabs 9 and 9′ is provided with ridges 11 and 11′ to enable the clip to be locked in one of two positions, thus providing variability in the grip provided. Further ridges may be provided to give added variability. It can be seen that, in order for the ratchet mechanism to be disengageable by twisting the clip, the ridges 11 and the pawls 12, 12′ are aligned substantially parallel to the axis of the ring.

In this embodiment, the protruding grip portions, 13, 13′ are sized to accommodate the thumb and finger of a user and are provided with a ridged surface, 14, 14′ to aid grip. The clip is of one piece of plastics construction. In order to improve the strength of the device, a fillet 21, 21′ is provided between each protruding grip portion 13, 13′ and the outer face 5 of the ring.

The inner face 4 of the ring is also ridged, in order to increase the grip of the clip to an object it is securing. For example, the clip may be used to secure the top of a plastic bag, such as a rubbish bag, and the ridges on the inner face 4 upper clip assist in making a firm closure. In this embodiment, the ridges on the internal face 4 lie in a direction approximately parallel to the axis of the ring. In other embodiments, one or more ridges may be disposed generally circumferentially around the inner face 4 of the ring thus providing point pressure on an item gripped by the clip. Embodiments such as this would be of particular use in securing e.g. a flexible pipe to a pipe stub.

FIG. 8 illustrates a cross-section through the clip of FIGS. 6 and 7, perpendicular to the axis of the clip ring.

FIGS. 9 and 10 illustrate the functioning of the annular slot 20 in especially preferred embodiments of the invention. For the sake of clarity, the tab and slot portions are not illustrated in FIG. 9 or 10. FIG. 9 illustrates a schematic cross-section through a split ring of a clip not provided with a slot. It can be seen that for some materials of construction, when the split ring is taken from its original configuration illustrated in FIG. 9(a), towards its closed configuration illustrated in FIG. 9(b) by bringing the two gap faces 7 and 8 together, the hole in the ring may become progressively more oval in shape. For some applications, this may be undesirable.

By piercing the ring with an annular slot 20 as illustrated in the cross-sections of FIG. 10, two connected ring portions 25 and 26 are effectively created, joined at their gap faces 7 and 8. With this configuration, as the ring is deformed from its initial configuration illustrated in FIG. 10(a) towards a closed position illustrated in FIG. 10(b), deformation of the ring is reduced by the abutment of the inner ring portion 26 with the outer ring portion 25, as illustrated. The introduction of the annular slot also makes the clip easier to close; this is especially important where the clip is to be operated by hand.

Also, when the clip is moved into it closed configuration, the width of the annular slot 20 becomes reduced. This feature has further advantages in that the annular slot 20 may therefore be used to grip a further item between the inner and outer ring portions 25 and 26. Hence, a clip of this configuration may be used, for example, to affix a sign to a post by placing a portion of the sign, or a projection therefrom in the annular slot 20 before the clip 1 is secured around a post. When the clip is so secured, the annular gap 20 narrows, thereby gripping and holding the sign in position.

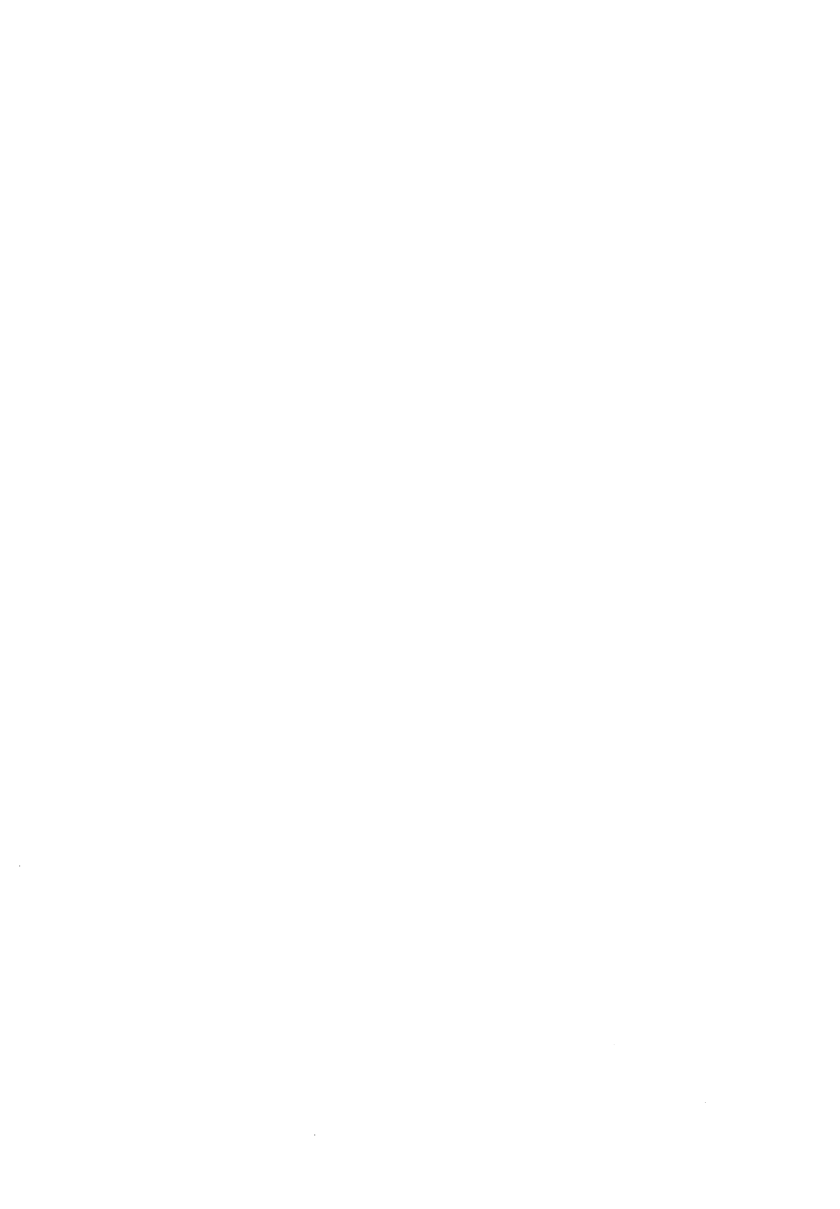

FIG. 18 illustrates a yet further embodiment of the invention having a deformable ring and a slot 20 between the two end faces of the ring. In this embodiment an abutment block 40 is provided in the slot 20, located between the outer ring portion 25 and the inner ring portion 26, to create a narrowing in the slot 20 between the two ring portions. The abutment block, and therefore the narrowing of the slot 20, is preferably located substantially opposite the split in the ring defining the gap faces 7 and 8 so that the block spans the two ring portions 25, 26 at point where they are closest when the outer ring 25 deforms on ring closure. As the clip is moved between its open configuration illustrated in FIG. 18(a) towards its closed position, the abutment block 40 spans the gap between the inner ring portion 26 and the outer ring portion 25 thereby transmitting force from one to the other, further reducing deformation of the inner ring portion 26 from its initial shape, as illustrated in FIG. 18(b). In this example, the abutment block is mounded integrally into the outer ring portion 25, but could equally be part of, or attached to either ring portion, or located between the two ring portions by other means.

FIG. 19 illustrates, in perspective view, an embodiment of a clip, generally indicated by 1, having such an abutment block 40 located between the inner and outer ring portions 25, 26 of the ring.

In other embodiments of the clip, the protruding portions 13 may be extended even further, to create carrying handles. In this way, the clip can be attached to e.g. a pipe, thus providing a secure and convenient mechanism to aid handling of the pipe.

FIG. 11 illustrates a clip assembly having two clips 1A and 1B joined together at an edge region of the deformable ring. FIG. 11 illustrates a particularly preferred embodiment where the two clips are of the form having a slot 20 between two end faces of the ring, although such a clip assembly is equally envisaged with other clip embodiments described herein. The provision of multiple clips allows two items to be effectively clipped together by allowing a first item to be encircled by a first clip, and a second item to be encircled by a second such clip. Positioning adjacent clips in different orientations allows the clips to be operated without the lever portions 13 on adjacent clips fouling each other. Such multiple clips will find particular application in e.g. the horticultural field where they might be used to secure a plant stem to a support. In this context it is envisaged that the two clips might be of different sizes, for example one clip might be so sized as to readily clamp to e.g. a bamboo cane or a wire whilst the other clip might be of a greater diameter to encircle the stem of a plant without crushing it, and to allow movement of the plant stem relative to the plant clip.

FIG. 12 illustrates a further embodiment of a clip assembly this time having four clips, 1A-1D, arranged generally in a loop and again joined to each other at edge regions of the deformable rings. Again, adjacent clips have different orientations. Such an assembly might be used to create a supporting structure for horticultural use by e.g. clipping the ends of four bamboo canes into each of the clips and splaying the other ends, thereby creating a pyramidal plant support structure. After use, the clips can be readily removed from the canes for re-use in the next season.

FIG. 13 illustrates a configuration similar to that of FIG. 12 but wherein adjacent clips are adjoined to each other via a cross-member 30 itself attached or formed as part of an edge region of each of the clips 1A-1D.

FIG. 14 illustrates yet a further embodiment of a multiclip assembly. In this case, the clips are disposed adjacent each other, forming a generally linear arrangement, or band, of clips.

In the embodiments illustrated in FIGS. 11-14, the axes of the rings of each individual clip member are illustrated in the same plane. In further embodiments of the invention, however, it is envisaged that at least one of the clips in such a multi-clip assembly would be positioned such that the axes of the rings are not parallel. For example, in the arrangement of FIG. 11, the two clip elements 1A, 1B can be orientated at an angle to each other, e.g. at 90°, to allow the construction of structures from elongate members held by the clips. For example one of the clip portions of the multiclip assembly might be clipped on to a vertical post, thereby orientating the second clip member to grip and hold a second post or rod horizontally, at 90° to the first post.

In yet further preferred embodiments, three such clips may be arranged in a multiclip assembly, the clips being arranged such that the axes of the clips are aligned along three mutually-perpendicular spatial axes. In this way the clips may be used to secure the corners of space-filling frameworks. Again using the horticultural context as an example, such clips might be used to aid the construction of fruit cages, constructed from bamboo canes.

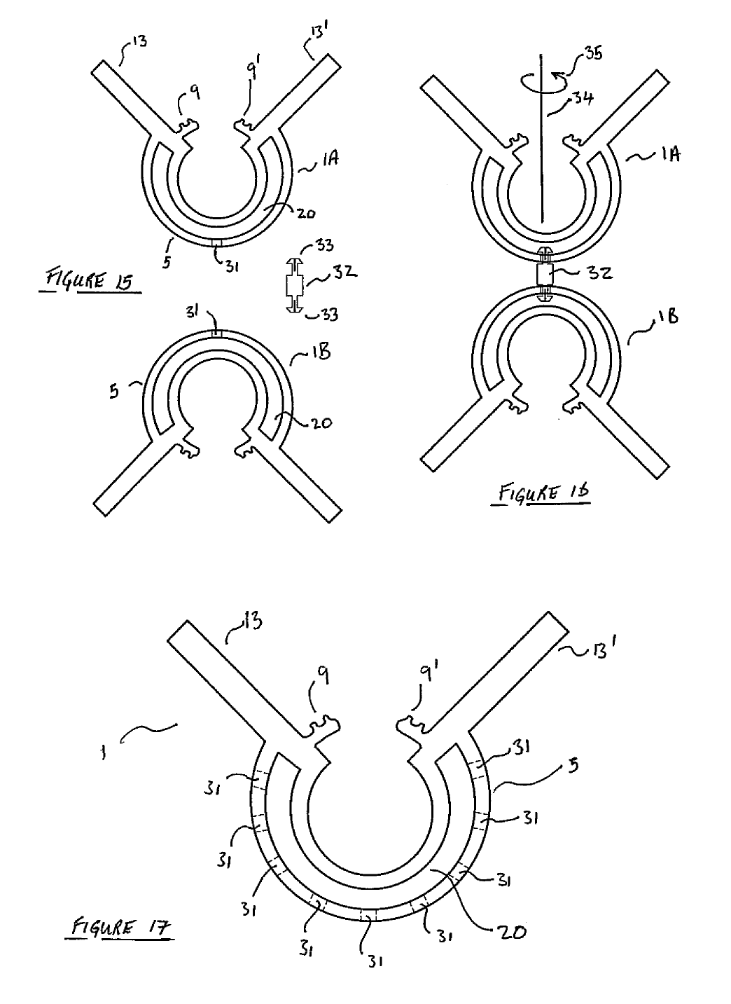

FIG. 15 illustrates two clips according to a further embodiment of the invention. Each of the clips 1A, 1B has connection means to enable the clip to be connected to a like clip. In this embodiment, this connection means comprises a hole 31 passing through the outer face 5 of the ring and communication with the annular slot 20 running between the two end faces of the ring. The connection means also comprises a connecting unit 32 having a deformable stud 33 that may be pushed through the hole 31 in the ring and snap into position thereby locking the stud 32 to the ring 1A, 1B. In this embodiment, the use of a stud and hole arrangement as the connection means provides a rotatable connection between the clips. In this way, one of the clips may be rotated relative to the other around the axis of the connector as illustrated by line 34 and arrow 35 in FIG. 16. In alternative embodiments, it is envisaged that the connection can be non-rotatable, and so shaped as form a connection between clips at one or more pre-determined angles. For example, the provision of a connector having a cross-shaped cross-section and a corresponding cross-shaped hole within the ring would allow rings to be connected to each other such that the axes of the rings were either parallel, or at right angles to each other.

FIG. 17 illustrates a yet further embodiment of the invention comprising a clip generally indicated by 1, wherein the clip has a plurality of connection means to enable the clip to be connected to a like clip. In this embodiment, this is provided by a plurality of holes 31, located around the perimeter of the outer face 5 of the ring and communicating with the slot 20 between the two end faces of the ring. In this way, multiple like rings may be joined to each other by use of a connector 32 illustrated in FIG. 15.

1. A clip comprising:
a ring of deformable material;
said ring having a split defining a gap between opposing gap faces of said ring;
one gap face having a tab and the other gap face having a hole configured such that the tab enters the hole of the opposing gap face when the ring is deformed to bring said opposing gap faces together;
the tab and hole being provided with a ratchet mechanism to resist removal of the tab from the hole; and
outwardly protruding gripping portions located on the outer face of said ring to act as levers, thereby enabling a user to bring said gap faces towards each other by bringing the gripping portions together.

2. A clip according to claim 1 comprising two such tabs and holes.

3. A clip according to claim 2 wherein each opposing gap face has a tab and a hole.

4. A clip according to claim 1 wherein said ring has an end face, and the hole or holes are open to an end face of the ring, whereby the ratchet mechanisms may be released by twisting the ring and thereby displacing the gap faces relative to each other along the direction of the axis of the ring.

5. A clip according to claim 4 wherein said ring has two end faces, and wherein said holes are each open to both end faces of the ring, thereby allowing the ratchet mechanisms to be released by twisting the ring in either of two directions.

6. A clip according to claim 1 wherein the hole and tab of each gap face are positioned adjacent each other along the axial dimension of the ring.

7. A clip according to claim 1 wherein said ring is provided with an annular slot between each end face.

8. A clip according to claim 7 further comprising an abutment block located within said slot.

9. A clip according to claim 1 wherein the inner face of said ring is ridged.

10. (canceled)

11. A clip according to claim 1 further comprising a connector to enable the clip to be connected to a like clip.

12. A clip according to claim 11 wherein said connector is located on said ring.

13. A clip according to claim 11 wherein said connector is releasable.

14. A clip according to claim 11 wherein said connector provides a rotatable connection to a like clip.

15. A clip according to claim 11 comprising a plurality of such connectors.

16. A clip assembly comprising a plurality of clips according to claim 1, each of said clips being joined to an adjacent clip.

17. A clip assembly according to claim 16 wherein at least two of said clips are oriented such that the axes of their rings are non-parallel.
